(19) United States
(12) Patent Application Publication
(10) Pub. No.: US 2005/0273693 A1
(43) Pub. Date: Dec. 8, 2005

(54) Build-a-deck custom presentation tool

(76) Inventor: David J. Peterson, Springboro, OH (US)

Correspondence Address: STEPHEN R. LOE, THE LAW OFFICE OF STEPHEN R. LOE, P.O. BOX 649, FRISCO, TX, 75034, US

(21) Appl. No.: 10/862,655

(22) Filed: Jun. 7, 2004

(51) Int. Cl. G06F 17/21

(52) U.S. Cl. 715/500.1; 715/730

(57) ABSTRACT

A method, system, and computer program product for creating a customized presentation in a networked computing environment using a set of pre-created presentation modules is provided. In one embodiment, a user accesses a set of pre-created presentation modules in a custom presentation tool via a network. The custom presentation tool presents the user with set of pre-created presentation modules from which the user selects a subset which is then presented to the user. The user may then rearrange the subset of presentation modules in an order determined by the user and the subset is then presented to the user in the rearranged order. Once the user is satisfied with the order, the custom presentation tool creates a presentation from the subset of presentation modules as arranged by the user which then may be opened by the user or saved to a storage device by the user.

### BACKGROUND OF THE INVENTION

1. Technical Field

The present invention relates generally to computer software and, more particularly, to electronic mail and embedded universal resource locator links.

2. Description of Related Art

Presentation tools, such as Power Point presentation software, are an important resource for many enterprises. Sales and marketing representatives may utilize presentation tools as part of a sales pitch to a prospective client. Engineers within an enterprise may utilize these tools to explain a new technology or product offered by an enterprise.

In the prior art, in order to save time for various individuals within an organization that need to present ideas to an audience, many pre-created presentation slide decks were stored within a central repository and made available to users within an organization for use in those individual's speeches, marketing pitches, or other presentations. This technique is especially useful for large organizations since there is a wide variety of information about an enterprise or subject that is useful to place in a presentation, but that any particular individual may not have access to the most recent information and/or not have time to continually update a personal slide show to keep abreast of the latest developments in the enterprise. Thus, the centralized repository provides a place where individuals may acquire slide shows having the latest information. Others within the enterprise may be tasked with the job of maintaining the slide shows and keeping the information up to date.

However, one common problem with the prior art is that the pre-created slide shows, because of the generalness of the slide shows in order to keep them useful for a wide variety of users and audiences, often did not provide the users within an enterprise with a slide show that was tailored closely enough with the needs of the users to be most beneficial. A common complaint was that the slide shows presented too much information in certain areas for an intended audience of the user or, conversely, that the slide show did not provide enough information about an area for a specific audience of the user. Therefore, it would be desirable to have a method, system, and computer program product that allows for the centralized maintenance of a set of approved common presentation slides or other media while still allowing enough customization to allow the user to create a presentation appropriate for the audience and use intended to be made of the presentation by the user.

### SUMMARY OF THE INVENTION

The present invention provides a method, system, and computer program product for creating a customized presentation in a networked computing environment using a set of pre-created presentation modules. In one embodiment, a user accesses a set of pre-created presentation modules in a custom presentation tool via a network. The custom presentation tool presents the user with set of pre-created presentation modules from which the user selects a subset which is then presented to the user. The user may then rearrange the subset of presentation modules in an order determined by the user and the subset is then presented to the user in the rearranged order. Once the user is satisfied with the order, the custom presentation tool creates a presentation from the subset of presentation modules as arranged by the user which then may be opened by the user or saved to a storage device by the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server is depicted in accordance with the present invention;

FIG. 3 depicts a block diagram of a data processing system in which the present invention may be implemented;

FIG. 4 depicts a diagram illustrating an exemplary process flow and program function for creating a customized presentation utilizing pre-created presentation media, such as, for example, slide decks, in accordance with one embodiment of the present invention;

FIGS. 5-8 depict exemplary screens that may be displayed to a user when creating a presentation using the custom presentation tool of the present invention;

FIG. 9 depicts a screen 900 illustrating an exemplary administration interface for a custom presentation tool in accordance with one embodiment of the present invention;

FIG. 10 depicts a screen for adding a new group;

FIG. 11 depicts a screen for adding a new subgroup; and

FIG. 12 depicts a screen for adding a new presentation.

### DETAILED DESCRIPTION OF THE PREFERRED EMBODIMENT

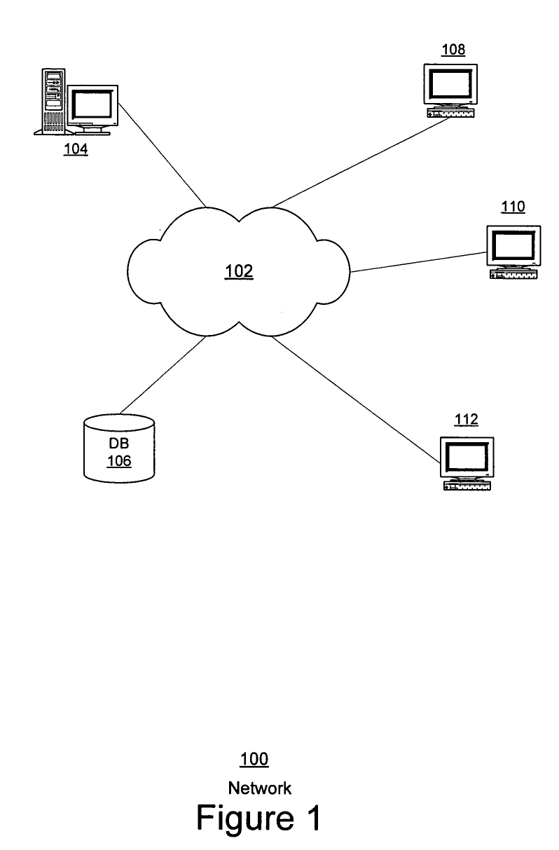

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with storage unit 106. In addition, clients 108, 110 and 112 are also connected to network 102. These clients, 108, 110 and 112, may be, for example, personal computers or network computers. For purposes of this application, a network computer is any computer coupled to a network that receives a program or other application from another computer coupled to the network. In the depicted example, server 104 provides a custom presentation tool (also referred to herein as Build-a-Deck or CPT) to clients 108-112. Clients 108, 110 and 112 are clients to server 104. Distributed data processing system 100 may include additional servers, clients, and other devices not shown. The CPT may be made available to clients 108, 110, and 112 via network 102 through a web browser on the clients 108, 110, and 112 or through some other publicly available or customized interface. A set of slide decks and/or other media files are maintained on a centralized storage unit, such as, for example, storage unit 106. Although depicted as separate from server 104, storage unit 106 may be incorporated in server 104 in some embodiments. In other embodiments, storage unit 106 may actually be a plurality of storage units possibly geographically diverse from one another.

To prevent unauthorized access to the presentation materials and to protect trade secrets and other proprietary information belonging to the enterprise, appropriate security measures may be taken, such as, for example, encrypting data transmitted between the sever 104 and clients 108, 110, and 112, requiring user identifications and passwords, and utilizing virtual private networks (VPNs). Other security measures may be taken as well commiserate with the needs of the particular implementation of the present invention.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet or a local area network.

FIG. 1 is intended as an example and not as an architectural limitation for the processes of the present invention.

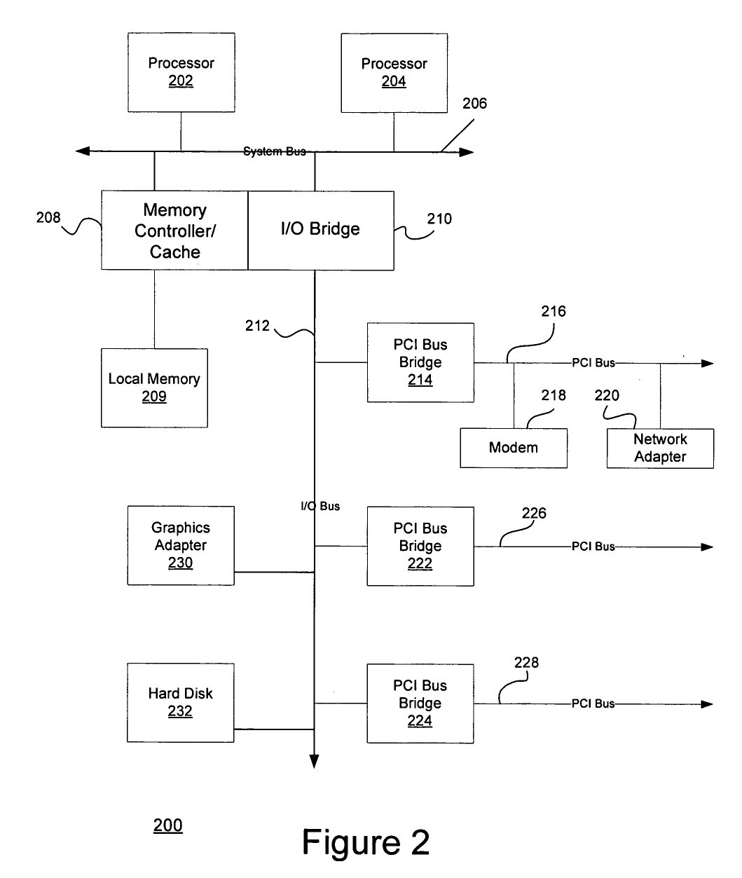

Referring to FIG. 2, a block diagram of a data processing system which may be implemented as a server, such as server 104 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries. The CPT runs on the operating system and provides a tool for clients to access centralized presentation media, such as slide decks, and to create a customized presentation show.

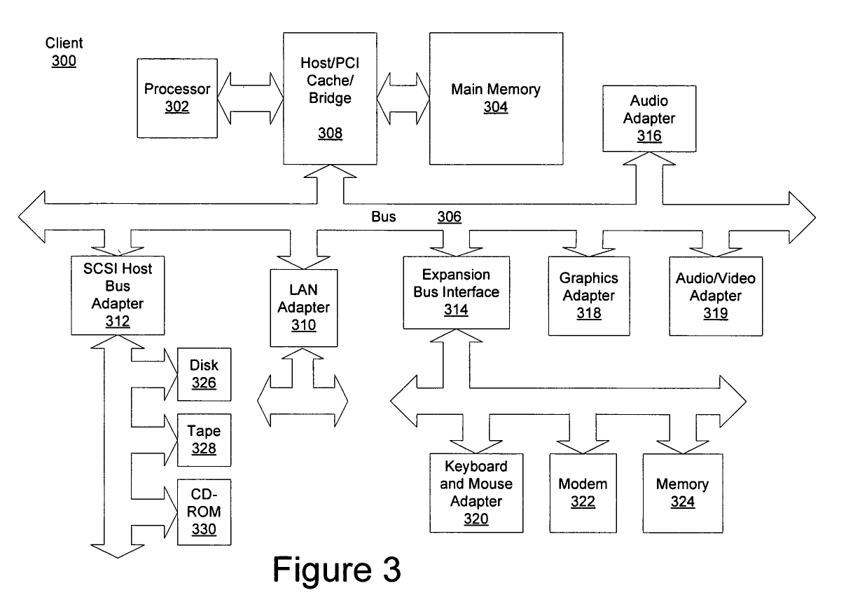

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 300. A web browser or other interface also runs on data processing system 300 allowing a user to access the CPT on a remote server. Instructions for the operating system, the object-oriented operating system, the web browser or other CPT interface, and other applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

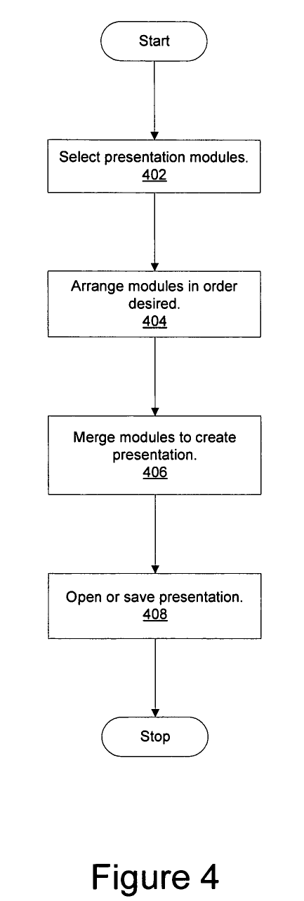

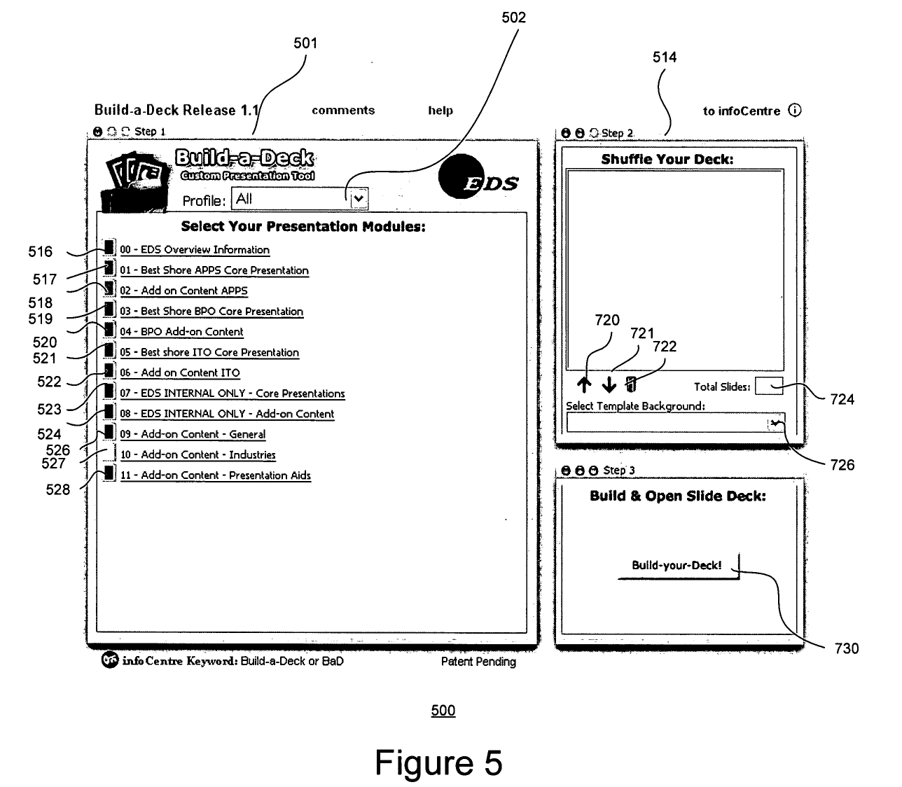

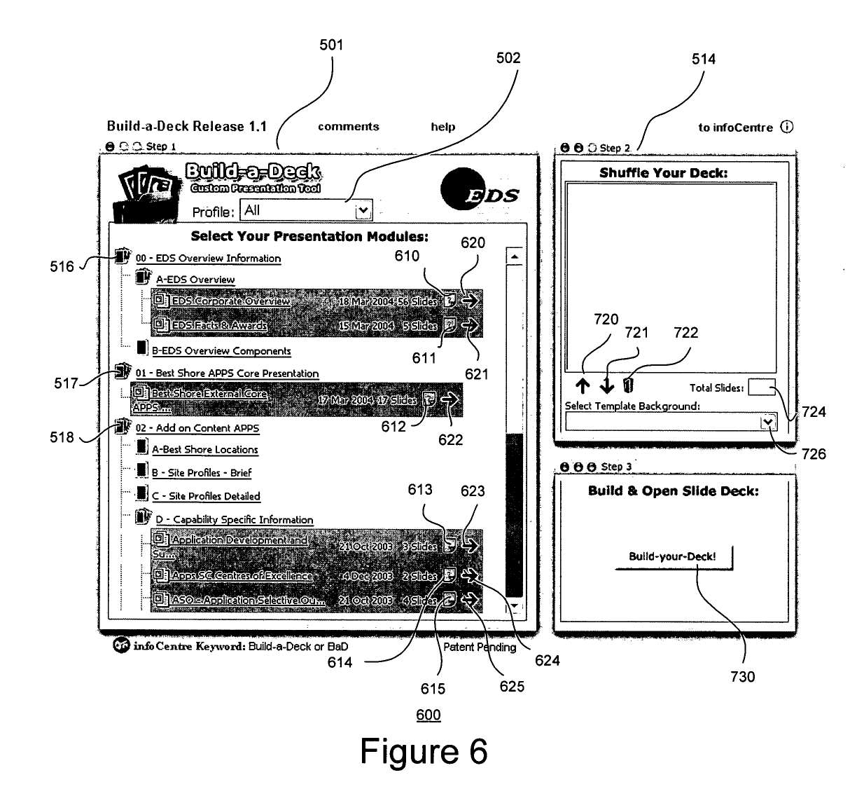

With reference now to FIG. 4, a diagram illustrating an exemplary process flow and program function for creating a customized presentation utilizing pre-created presentation media, such as, for example, slide decks, is depicted in accordance with one embodiment of the present invention. To begin, after a user logs on to, engages or otherwise accesses the CPT, the user selects presentation modules (step 402). Exemplary Graphical User Interface (GUI) screens 500 and 600 with exemplary presentation groups for executing this step are depicted in FIGS. 5 and 6. This step provides a simple tree like structure that will enable presentations to be aligned at a “Group” or “Sub-Group” level. To expand a “Group” or “Sub-Group” within Step 1 window 501, a user simply clicks on a shaded slide icons 516-528. An example of a screen that may be presented to a user after expansion of several groups is depicted in FIG. 6. In this example, the groups EDS Corporate Overview, Core Presentation Starting Point Modules, and Add-on Content Modules corresponding to shaded slide icons 516-518 respectively. The Profile selection icon 502 controls what is displayed in the initial view of the tree like structure. Profiles can be ALL, or others defined to meet organizational needs. These profiles provide a pre-selected list of Groups to be displayed for the user.

A user can easily open or save an individual Presentation module by selecting the entry from the PowerPoint Icon or actual module title. In one embodiment, the presentation module last save date is displayed along with the number of slides. Additional module information can be obtained by clicking on one of the “?” (Question Mark) icons 610-615. Additional information includes detailed description, author name and actual file size.

To “ADD” a presentation module, you click the “=>” (RH Arrow) icon 620-625. This action will add the selected module to the Step 2 window 514. As a user Adds additional modules, the additional modules are placed at the bottom of the list displayed in the Step 2 window 514.

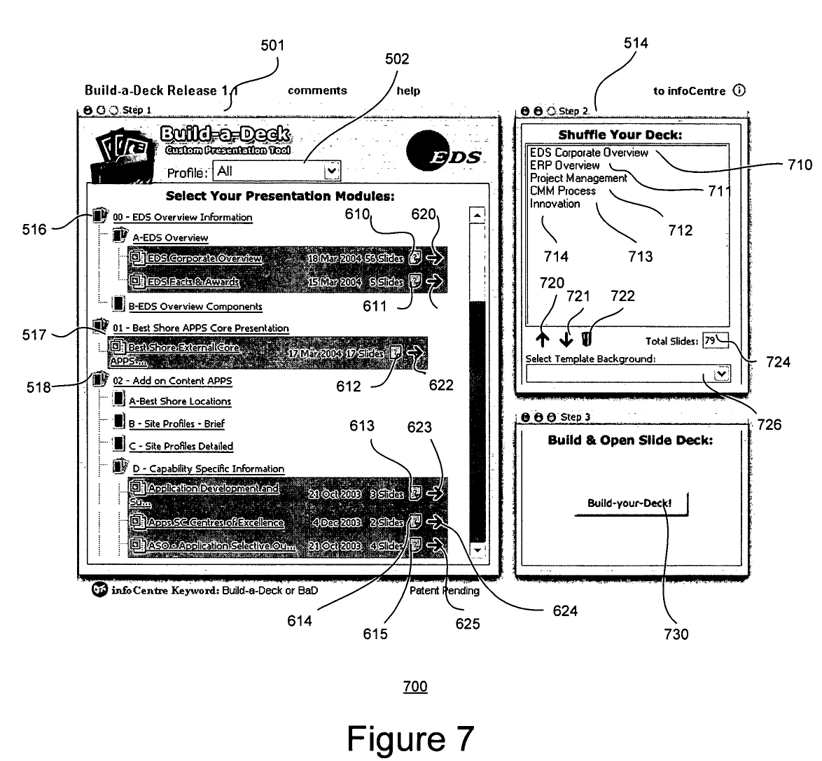

FIG. 7 depicts an exemplary GUI screen 700 that may be displayed to a user after having selected presentation modules for inclusion in the user's presentation. The step 2 window 514 shows that the user has included modules EDS Corporate Overview 710, ERP Overview 711, Project Mgmt 712, CMM Process 713, and Innovation 714.

Next, a user arranged the modules in the order desired (step 404). This step enables the user to rearrange individual modules in the appropriate order desired. To rearrange the slide deck modules 710-714, a user selects the module 710-714 that is desired to be moved and then uses the “Up and Down” arrow icons 720 and 721 to move the module 710-714 as desired. You can also delete a prior added module 710-714 by selecting the module then clicking the “Garbage Can” icon 722 or the “delete” key on the user's keyboard. The total slide count of all selected modules 710-714 is displayed in counter box 724 so that a user can easily see how large the slide deck currently is.

The final activity in Step 404 is to select the desired “Presentation Background Template” from the drop down selection list 726. This will apply the selected presentation background (color) and standard slide footer information to the entire deck being created.

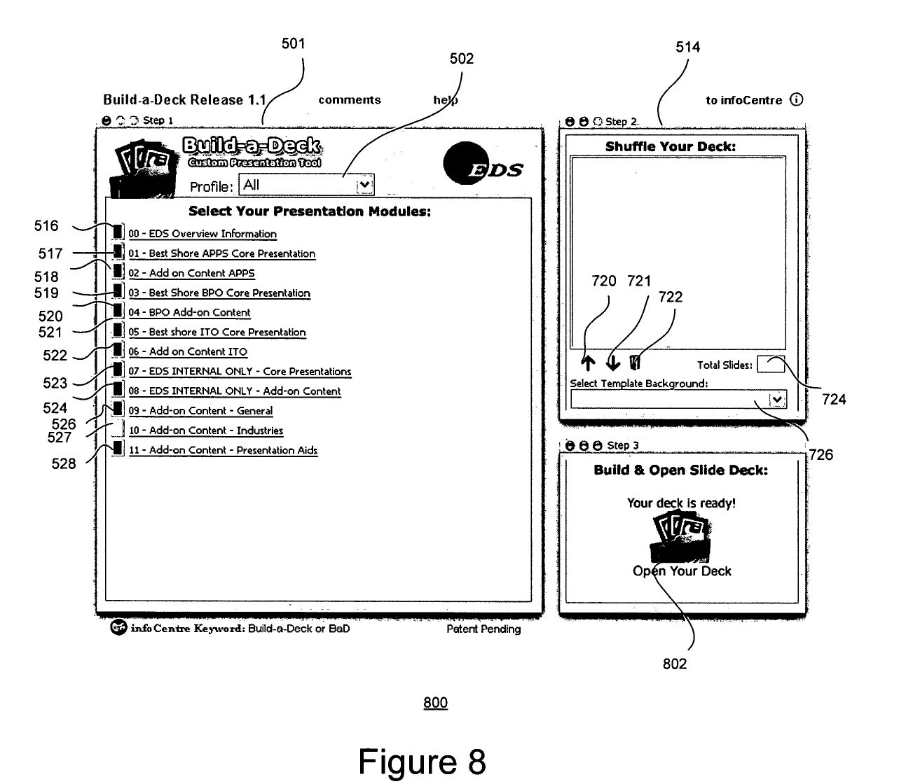

Next, the user merges the modules to create a presentation (step 406). This step activates the merging activity of all selected modules. A user simply clicks on the “Build-Your-Deck!” button 730 to initiate the action. Merging modules, such as, for example, Power Point modules, into a single presentation is well known in the art. Once completed, the user may click on the “Your Deck is Ready—Open Your Deck” button 802 as shown in GUI screen 800 depicted in FIG. 8 to initiate a dialog window that enables a user to open or locally save the created custom presentation (step 408).

The actual step 406, Build the Deck, may be performed on the web server or on the client's personal computer (PC). In a one embodiment, the client's PC is utilized for performing this step in order to enable greater flexibility and portability of the application for other subject areas. Performing step 406 on the web server would most likely increase the actual speed (time) to create the new slide deck, but would require additional software to be available on each hosting web server.

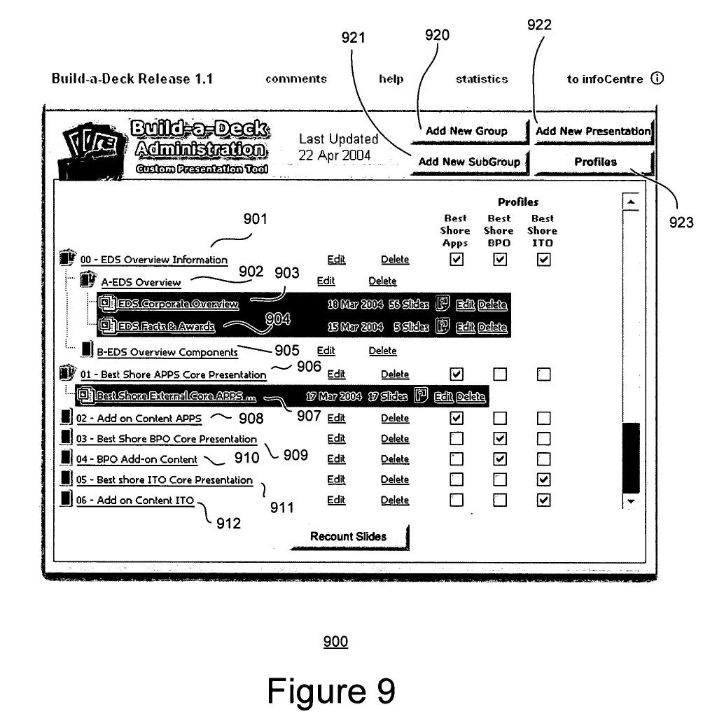

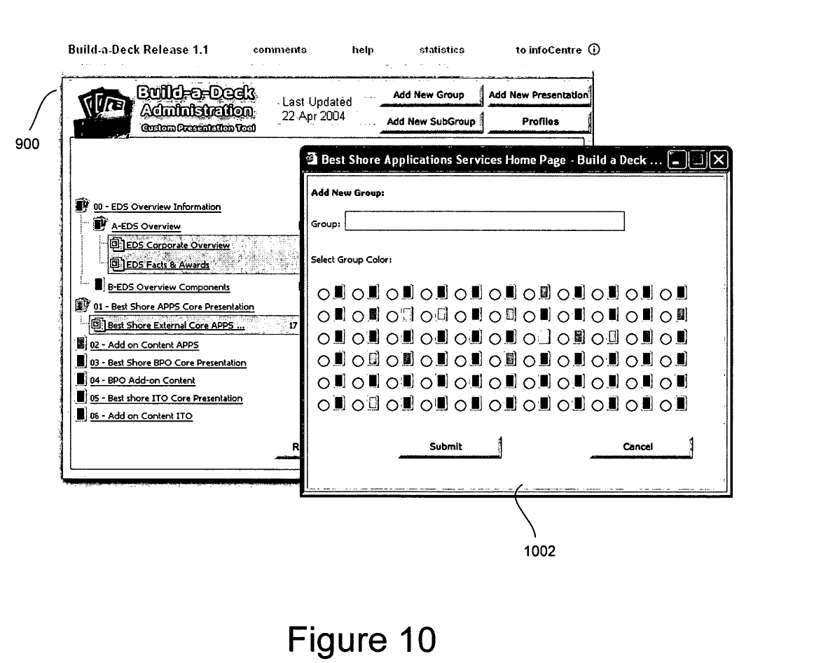

With reference now to FIG. 9, a screen 900 illustrating an exemplary administration interface for a custom presentation tool is depicted in accordance with one embodiment of the present invention. The administration aspects for Build-a-Deck are handled through a web GUI screen 900 that enables administrators to add, change or delete groups, sub-groups and presentation modules 901-912 through use of buttons 920-922. The alignment of groups and subgroups to defined Profiles is controlled through the selection of items as reflected in the GUI screen 900. The user can select or deselect items for inclusion on the profile view. To add a group, the administrator simply clicks on the Add New Group button 920 and then enters the information that is requested in a dialog box 1002 that appears over the build-a-deck administration window 900 as depicted in FIG. 10. This information may include the name of the group and the selection of the group color that will appear next to the group, such as, any of groups 901, 906, 908-912, in the Step 1 tree structure 920 and all other tree structure display views.

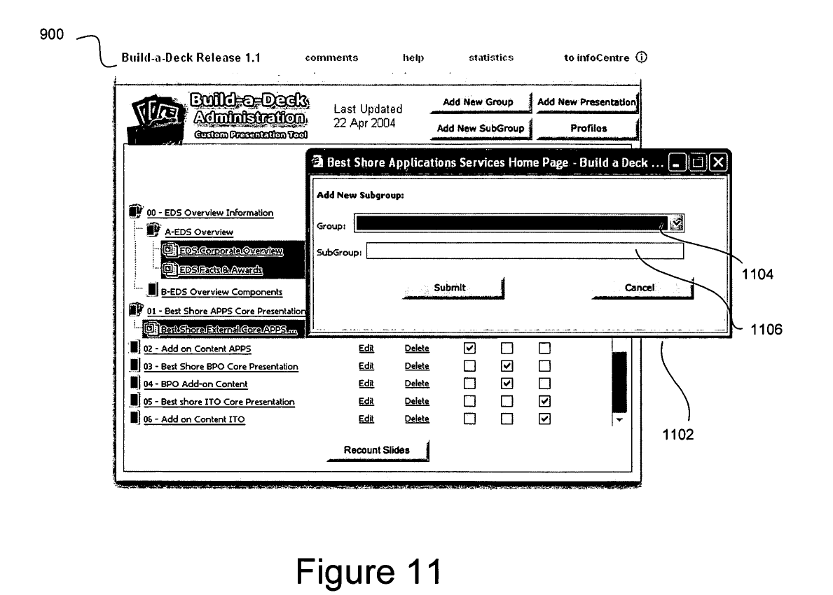

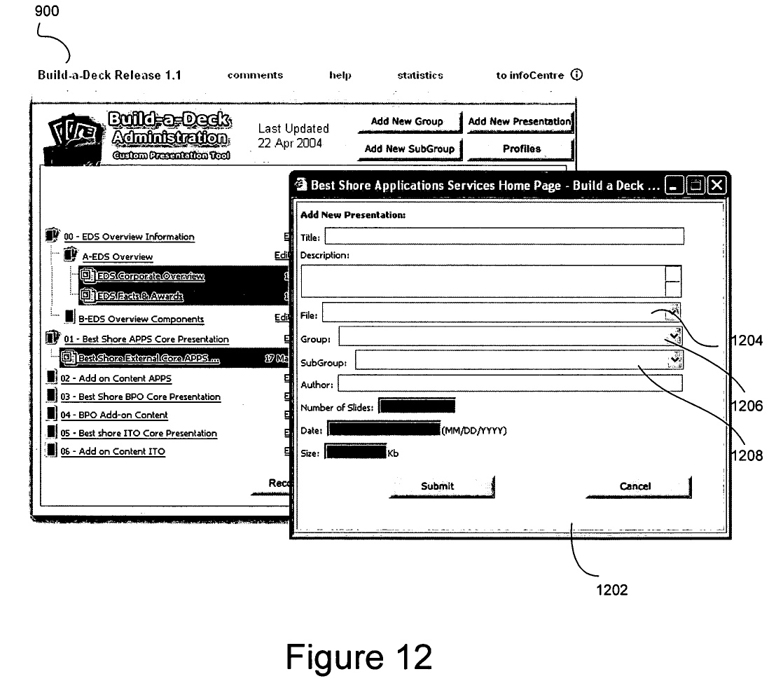

When adding a new subgroup, the administrator simply clicks on the Add New SubGroup button 921 and then enters the information that is requested in a dialog box 1102 as shown in FIG. 11. This includes the corresponding Group selection from the group selection drop down selection field 1104, then the entering of the actual SubGroup Description in the provided field subgroup 1106. The adding of subgroups enables you to establish the relationship to a respective group level.

When adding a new presentation, the administrator simply clicks on the Add New Presentation, button 922 and then enters the information that is requested in a dialog box 1202. This includes entering the Title, Description and Author. The following data elements are selected from provided drop-down selection lists 1204-1208: File Name 1204, Group 1206, SubGroup 1208. In some embodiments, the following final information would be determined by the CPT: Number of slides, date file was last saved, and the file size.

When adding presentations, as described above, an administrator establishes the relationship to either a Group or Sub-Group level and provides the additional description information, author and selects the actual presentation from the available presentations in a master presentation directory or other directory available to the administrator. The administrator or others within the enterprise may be tasked with creating and maintaining the presentations in the master presentation directory.

To add a new Profile, the administrator simply clicks on the Profiles button 923 and then selects an option to Add a new profile, which includes enter the profile name; edit an existing profile that allows modification of existing profile name; or delete and existing profile. The CPT would provide the appropriate screen prompts to collect the required information to execute the desired activity.

The present invention may also include tracking and statistic modules or components to allow a user or an administrator to track the usage of various presentations by individuals. The present invention may also provide the last date a presentation was used as well as the frequency of use of any presentation. In fact, any and/or all aspects of usage may be monitored so that, for example, an enterprise can gain insight into the time savings in hours and estimated reuse value percentage generated by the use of the Build-a-Deck tool. This information is used to determine how to make better use of presentations.

The present invention provides, in one embodiment, a web-based application that provides users global access (with appropriate security authorization) and ability to create there own customized PowerPoint or other type slide deck in a real time manner. The present invention allows users to create the slide deck using current information that would provide a starting template that requires minimal tailoring and customization to create the final slide deck that will include information in the appropriate level of detail and organized in the manner deemed most suitable by the user rather than someone else within the enterprise not familiar with the intended audience or use of the presentation.

The present invention has been described primarily in the context of presentation slides such as those commonly used in, for example, Power Point which is a presentation software tool available from the Microsoft Corporation of Redmond, Wash. However, the present invention is not limited to use with Power Point nor is it limited to use with presentation slides. Other media may be utilized as well, for example, Microsoft Word documents, presentation modules may include video, animation, and other graphics in addition to slides, and may also include audio, such as, for example, sound effects and music.

The terms “click” and “clicking” have been used throughout to indicate that a user has positioned a cursor over a portion of the screen by means of a mouse or other pointing device and selected an item associated with that section of the screen by pushing a button associated with mouse or other pointing device. However, this is not intended to imply any limitations regarding the selection of items in the present invention, but is merely used to describe one method that may be utilized to select an item. As those skilled in the art will recognize, other methods of selection may be utilized without departing from the scope or spirit of the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for creating a customized presentation in a networked computing environment using a set of pre-created presentation modules, the method comprising;
accessing a set of pre-created presentation modules via a network;
presenting a subset of the set of pre-created presentation modules to a user responsive to selection of the subset by a user;
rearranging the subset of presentation modules in an order determined by the user in response to input by the user; and
creating a customized presentation from the subset of presentation modules as arranged by the user.

2. The method as recited in claim 1, further comprising:
opening the customized presentation for exhibition to an audience.

3. The method as recited in claim 1, further comprising:
saving the customized presentation to the user's data processing system.

4. The method as recited in claim 1, wherein the presentation modules comprise media of at least one of text, graphics, animation, video, and audio.

5. The method as recited in claim 1, further comprising:
responsive to a determination that a user desires to remove a presentation module from the subset of presentation modules, removing the selected presentation module from the display of the subset of presentation modules.

6. The method as recited in claim 1, wherein the set of presentation modules are arranged in groups and subgroups for presentation to the user in a treelike hierarchical structure.

7. The method as recited in claim 1, wherein the particular set of pre-created presentation modules presented to the user is selected based on a profile selected by the user.

8. The method as recited in claim 1, wherein the set of presentation modules and subset of presentation modules are presented in a graphical user interface.

9. A computer program product for use in a data processing system for creating a customized presentation in a networked computing environment using a set of pre-created presentation modules, the computer program product comprising;
first instructions for accessing a set of pre-created presentation modules via a network;
second instructions for presenting a subset of the set of pre-created presentation modules to a user responsive to selection of the subset by a user;
third instructions for rearranging the subset of presentation modules in an order determined by the user in response to input by the user; and
fourth instructions for creating a customized presentation from the subset of presentation modules as arranged by the user.

10. The computer program product as recited in claim 9, further comprising:
fifth instructions for opening the customized presentation for exhibition to an audience.

11. The computer program product as recited in claim 9, further comprising:
fifth instructions for saving the customized presentation to the user's data processing system.

12. The computer program product as recited in claim 9, wherein the presentation modules comprise media of at least one of text, graphics, animation, video, and audio.

13. The computer program product as recited in claim 9, further comprising:
fifth instructions, responsive to a determination that a user desires to remove a presentation module from the subset of presentation modules, for removing the selected presentation module from the display of the subset of presentation modules.

14. The computer program product as recited in claim 9, wherein the set of presentation modules are arranged in groups and subgroups for presentation to the user in a treelike hierarchical structure.

15. The computer program product as recited in claim 9, wherein the particular set of pre-created presentation modules presented to the user is selected based on a profile selected by the user.

16. The computer program product as recited in claim 9, wherein the set of presentation modules and subset of presentation modules are presented in a graphical user interface.

17. A system for creating a customized presentation in a networked computing environment using a set of pre-created presentation modules, the system comprising;
first means for accessing a set of pre-created presentation modules via a network;
second means for presenting a subset of the set of pre-created presentation modules to a user responsive to selection of the subset by a user;
third means for rearranging the subset of presentation modules in an order determined by the user in response to input by the user; and
fourth means for creating a customized presentation from the subset of presentation modules as arranged by the user.

18. The system as recited in claim 17, further comprising:
fifth means for opening the customized presentation for exhibition to an audience.

19. The system as recited in claim 17, further comprising:
fifth means for saving the customized presentation to the user's data processing system.

20. The system as recited in claim 17, wherein the presentation modules comprise media of at least one of text, graphics, animation, video, and audio.

21. The system as recited in claim 17, further comprising:
fifth means, responsive to a determination that a user desires to remove a presentation module from the subset of presentation modules, for removing the selected presentation module from the display of the subset of presentation modules.

22. The system as recited in claim 17, wherein the set of presentation modules are arranged in groups and subgroups for presentation to the user in a treelike hierarchical structure.

23. The system as recited in claim 17, wherein the particular set of pre-created presentation modules presented to the user is selected based on a profile selected by the user.

24. The system as recited in claim 17, wherein the set of presentation modules and subset of presentation modules are presented in a graphical user interface.
